(19) United States
(12) Patent Application Publication
(10) Pub. No.: US 2011/0032469 A1
(43) Pub. Date: Feb. 10, 2011

(54) METHOD OF MANUFACTURING DISPLAY DEVICE

(75) Inventors: Hee-Keun LEE, Suwon-si (KR); Nakcho CHOI, Seoul (KR); Taesung JUNG, Yongin-si (KR); Seung-Jin BAEK, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD, Suwon-si (KR)

(21) Appl. No.: 12/639,816

(22) Filed: Dec. 16, 2009

(30) Foreign Application Priority Data
Aug. 7, 2009 (KR) 10-2009-0072905

(51) Int. Cl. G02F 1/13

(52) U.S. Cl. 349/187

(57) ABSTRACT

In a method of manufacturing a display device, a first liquid crystal and a second liquid crystal obtained by doping the first liquid crystal with a dopant are injected into first, second, and third rooms, so that liquid crystal layers having different amounts of the dopant are respectively formed in the first, second, and third rooms. Thus, a manufacturing process of the display device is simplified and a manufacturing process efficiency of the display device increases, thereby reducing a manufacturing cost.

### CROSS REFERENCE TO RELATED APPLICATION

This application claims priority from and the benefit of Korean Patent Application No. 10-2009-0072905, filed on Aug. 7, 2009, which is hereby incorporated by reference for all purposes as if fully set forth herein.

### BACKGROUND OF THE INVENTION

1. Field of the Invention

Exemplary embodiments of the present invention relate to a method of manufacturing a display device. More particularly, exemplary embodiments the present invention relate to a method of manufacturing a liquid crystal display.

2. Discussion of the Background

A display device controls liquid crystals of which both physical properties of a solid arranged in one direction and a liquid having fluidity co-exist to display desired images.

In general, a display device includes a display panel displaying images and liquid crystals are disposed in the display panel. As an example of disposing the liquid crystals in the display panel, an injection method is widely used in order to inject the liquid crystals into the display panel after the display panel is assembled. However, a lot of processes are required to inject the liquid crystals into the display panel, thereby causing deterioration in manufacturing process efficiency and increase in manufacturing cost.

### SUMMARY OF THE INVENTION

Exemplary embodiments of the present invention provide a method capable of simplifying a manufacturing process for a display device.

Additional features of the invention will be set forth in the description which follows, and in part will be apparent from the description, or may be learned by practice of the invention.

An exemplary embodiment of the present invention discloses a method of manufacturing a display device as follows. A barrier pattern is formed on a first substrate, and a second substrate is coupled with the first substrate to form a first room, a second room, and a third room between the first substrate and the second substrate. The first room, the second room and the third room are separated by the barrier pattern. Liquid crystal layers are formed in the first room, the second room, and the third room, respectively, by using a first liquid crystal and a second liquid crystal by doping the first liquid crystal with a dopant. Each of the liquid crystal layers has a different amount of the dopant.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1A, FIG. 1B, FIG. 1C, FIG. 1D, FIG. 1E, and FIG. 1F are views illustrating a method of manufacturing a display device according to a first exemplary embodiment of the present invention.

FIG. 2A, FIG. 2B, FIG. 2C, and FIG. 2D are views illustrating a method of manufacturing a display device according to a second exemplary embodiment of the present invention.

FIG. 3A, FIG. 3B, FIG. 3C, FIG. 3D, and FIG. 3E are views illustrating a method of manufacturing a display device according to a third exemplary embodiment of the present invention.

FIG. 4A, FIG. 4B, FIG. 4C, and FIG. 4D are views illustrating a method of manufacturing a display device according to a fourth exemplary embodiment of the present invention.

FIG. 5A FIG. 5B, FIG. 5C, and FIG. 5D are views illustrating a method of manufacturing a display device according to a fifth exemplary embodiment of the present invention.

### DESCRIPTION OF THE ILLUSTRATED EMBODIMENTS

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

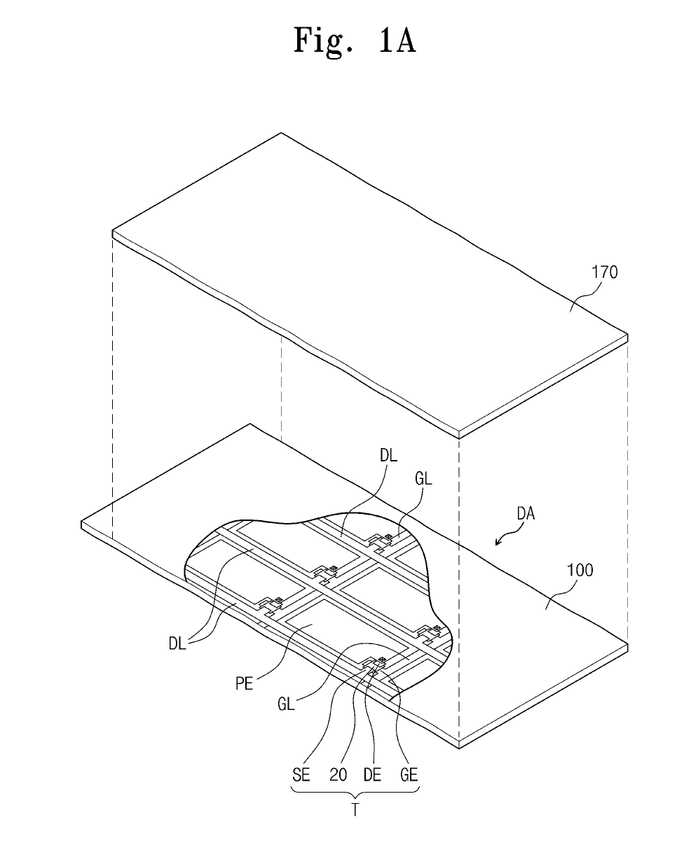

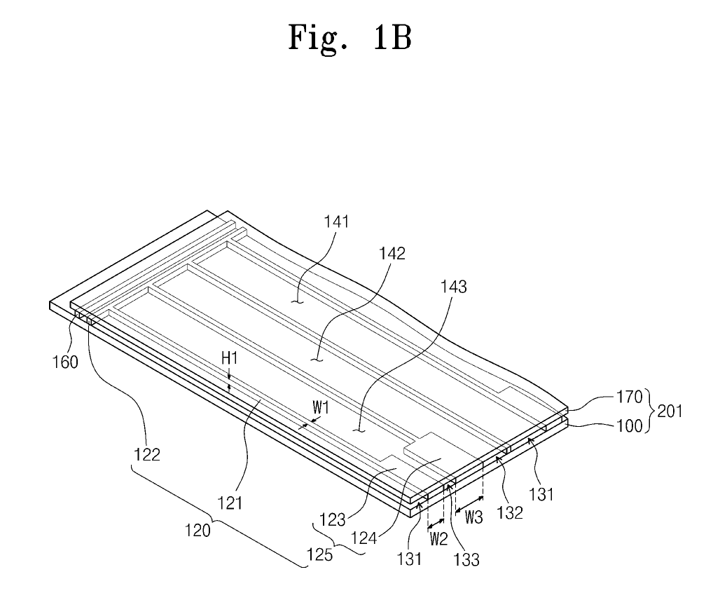

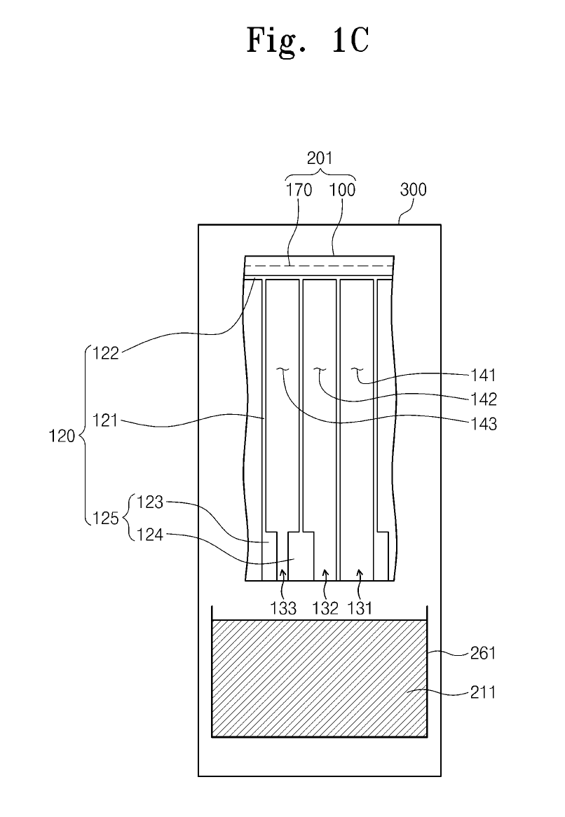

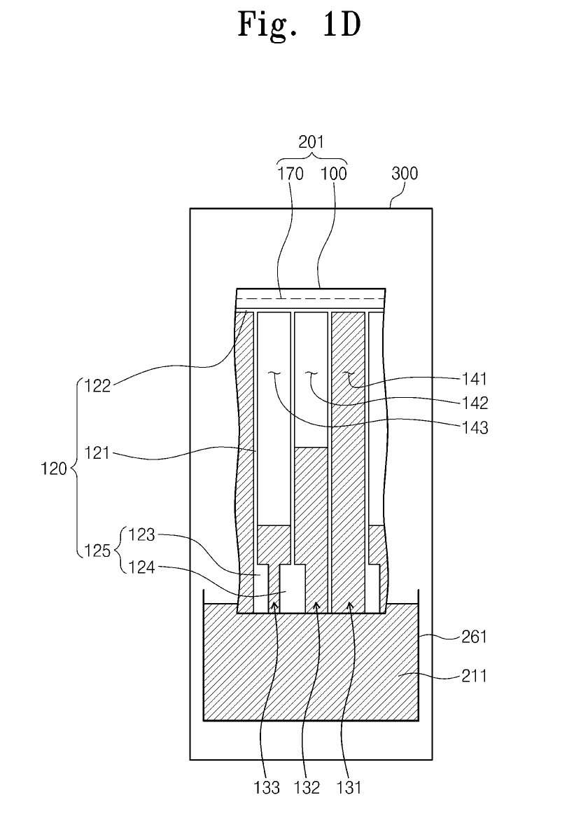

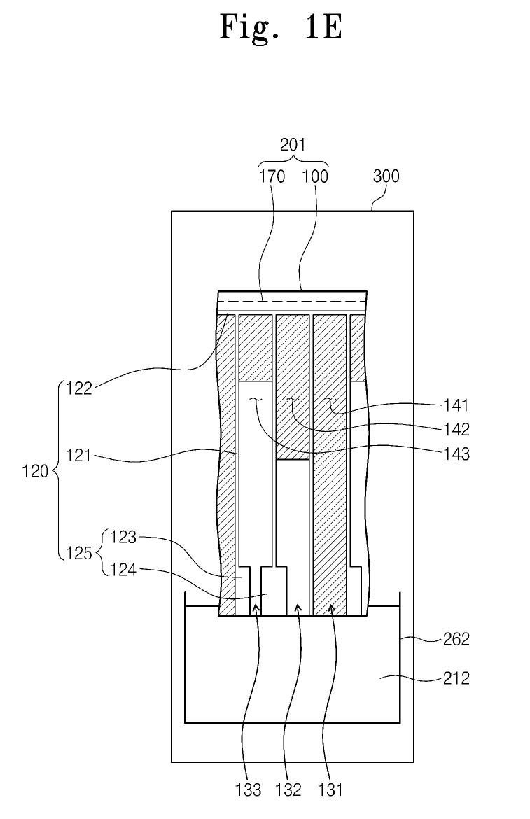

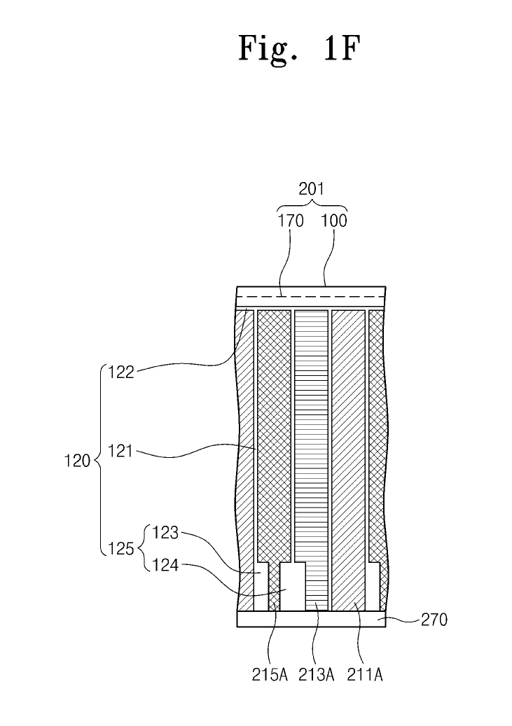

FIG. 1A, FIG. 1B, FIG. 1C, FIG. 1D, FIG. 1E, and FIG. 1F are views illustrating a method of manufacturing a display device according to a first exemplary embodiment of the present invention.

Referring to FIG. 1A, a first substrate 100 and a second substrate 170 are prepared. The first substrate 100 may be a transparent insulating substrate such as glass or plastic.

The first substrate 100 includes a display area DA and a peripheral area (not shown). The display area DA includes pixel areas in which images are displayed. A data line DL and a gate line GL are formed on the first substrate 100. The data line DL crosses with and is spaced apart from the gate line GL. Each pixel area includes a thin film transistor T that serves as a switch and a pixel electrode PE that is electrically connected to the thin film transistor T. The thin film transistor T includes a gate electrode GE, a source electrode SE, a drain electrode DE, and an active pattern 20. The gate electrode GE branches from the gate line GL, the source electrode SE branches from the data line DL, and the drain electrode DE is spaced apart from the source electrode SE. The active pattern 20 is arranged under the source electrode SE and the drain electrode DE and electrically connected to the source electrode SE and the drain electrode DE. Although not shown in FIG. 1, an absorbing layer (not shown) may be formed on a lower surface of the first substrate 100, which is opposite to an upper surface on which the pixel electrode PE is formed.

The second substrate 170 may be a transparent insulating substrate such as glass or plastic. A common electrode (not shown) is formed on the second substrate 170 to face the pixel electrode PE.

Different from the above-described active matrix type liquid crystal display, in the case of a passive matrix type liquid crystal display, first electrodes (not shown) may be formed on the first substrate 100 instead of forming the data line DL, the gate line GL, the thin film transistor T, and the pixel electrode PE. The first electrodes extend in a first direction and are spaced apart from each other. In addition, second electrodes (not shown) may be formed on the second substrate 170 instead of forming the common electrode. The second electrodes extend in a second direction substantially perpendicular to the first direction and are spaced apart from each other. In this case, areas at which the first electrodes cross with and overlap with the second electrodes may be pixel areas.

Referring to FIG. 1B, a barrier pattern 120 is formed on the first substrate 100. The barrier pattern 120 may be formed by coating an insulating material on the first substrate 100 and patterning the insulating material. The insulating material may be a photoresist. The photoresist may include a positive type photoresist, a negative type photoresist, or an organic black matrix. In addition, the barrier pattern 120 may be formed on the second substrate 170 instead of the first substrate 100.

An adhesive pattern 160 may be formed at an end of the first substrate 100 and adjacent to the barrier pattern 120. The adhesive pattern 160 is used to couple the first substrate 100 to the second substrate 170, and thus the adhesive pattern 160 may be formed on the second substrate 170. The adhesive pattern 160 may include an ultraviolet ray cured resin or a heat-cured resin. When a treatment process, such as a heat treatment process or a light treatment process, is performed with respect to the adhesive pattern 160, the adhesive pattern 160 is cured to couple the first substrate 100 to the second substrate 170, thereby completing a display panel 201.

Due to the coupling process using the adhesive pattern 160, a first room 141, a second room 142, and a third room 143, which are separated from each other by the barrier pattern 160, are formed between the first substrate 100 and the second substrate 170. The barrier pattern 120 may include a plurality of first barriers 121, a second barrier 122, and a width adjuster 125. The first barriers 121 extend in a first direction and are spaced apart from each other. The pixel electrodes PE (shown in FIG. 1A) may be arranged on the first substrate 100 exposed between the first barriers 121. Each of the first barriers 121 has a first width W1 and a first height H1. The second barrier 122 extends in a second direction substantially perpendicular to the first direction to connect first ends of the first barriers 121 with each other. The second barrier 122 may have the first height H1. As described above, a space between the first substrate 100 and the second substrate 170 may be divided into the first room 141, the second room 142, and the third room 143 by the first barriers 121 and the second barrier 122.

The first room 141 has a first inlet 131, the second room has a second inlet 132, and the third room 143 has a third inlet 133. Each of the first, second, and third inlets 131, 132, and 133 serves as a pathway for injection of liquid crystals. The first barriers 121 have second ends opposite to the first ends. The width adjuster 125 has the first height H1 and is formed at at least one end of the second ends. For example, the width adjuster 125 may include a first width adjuster 123 and a second width adjuster 124. The first width adjuster 123 is formed at the second end of the first barrier 121 positioned between the first room 141 and the third room 143 adjacent to the first room 141 and has a second width W2 wider than the first width W1. The second width adjuster 124 is formed at the second end of the first barrier 121 positioned between the second room 142 and the third room 143 adjacent to the second room 142 and has a third width W3 wider than the second width W2. Thus, each of the first inlet 131, the second inlet 132, and the third inlet 133 have a different size from one another, and the size of the first inlet 131, the second inlet 132, and the third inlet 133 decreases in the order of the first room 141, the second room 142, and the third room 143.

Referring to FIG. 1C, the display panel 201 including the barrier pattern 120 is transferred to and carried in a process chamber 300. A first receptacle 261 in which a first liquid crystal 211 is filled is prepared in the process chamber 300. The first liquid crystal 211 may be doped with a chiral dopant at a first amount. The display panel 201 carried in the process chamber 300 is located at a position spaced apart from the first receptacle 261. Then, when a pressure inside the process chamber 300 decreases, the first room 141, the second room 142, and the third room 143 may be in a vacuum state.

Hereinafter, for the convenience of explanation, the display panel 201 has been shown in cut-away views to show the first inlet 131, the second inlet 132, and the third inlet 133 and the first room 141, the second room 142, and the third room 143 with the barrier pattern 120. Although not shown in the figures, plural display panels may be carried in the process chamber 300 simultaneously in order to improve the productivity of the display panels.

Referring to FIG. 1D, when the pressure inside the process chamber 300 is increased after moving the display panel 201 to the first receptacle 261 such that the first inlet 131, the second inlet 132, and the third inlet 133 make contact with or are dipped into the first liquid crystal 211, the first liquid crystal 211 may be substantially simultaneously injected into the first room 141, the second room 142, and the third room 143. Although the first liquid crystal 211 is substantially simultaneously injected into the first room 141, the second room 142, and the third room 143, since the first inlet 131, the second inlet 132, and the third inlet 133 have the different sizes, an injection speed of the first liquid crystal 211 is different according to the size of the first inlet 131, the second inlet 132, and the third inlet 133. As a result, the first liquid crystal 211 may be injected into the first room 141, the second room 142, and the third room 143 in different amounts.

The injection process of the first liquid crystal 211 may be performed until the first room 141 is fully filled with the first liquid crystal 211 by increasing the pressure inside the process chamber 300 to an ambient atmosphere pressure, for example, 1 atmosphere. Consequently, the first liquid crystal 211 at a first amount is injected into the first room 141, the liquid crystal 211 at a second amount less than the first amount is injected into the second room 142, and the liquid crystal 211 at a third amount less than the second amount is injected into the third room 143.

Although not shown in the figures, after performing the injection process for the first liquid crystal 211, the first receptacle 261 is spaced apart from the display panel 201.

Referring to FIG. 1E, the display panel 201 is transferred to above a second receptacle 262 in which a second liquid crystal 212 is filled, or the second receptacle 262 is transferred to below the display panel 201. Then, the display panel 201 makes contact with or is dipped into the second liquid crystal 212. The second liquid crystal 212 may not include the chiral dopant. Since the pressure inside the process chamber 300 maintains the atmosphere pressure while transferring the display panel 201 or the second receptacle 262, the first liquid crystal 211 injected into the first to third rooms 141, 142, and 143 is not leaked from the first to third rooms 141, 142, and 143.

The pressure inside the process chamber 300 increases to inject the second liquid crystal 212 into the second room 142 and the third room 143. The injection process for the second liquid crystal 212 may be performed until the second room 142 and the third room 143 each of which is partially filled with the first liquid crystal 211 are filled with the second liquid crystal 212. The first room 141 is fully filled with the first liquid crystal 211, so that the second liquid crystal 212 is not injected into the first room 141 even if the injection process for the second liquid crystal 212 is performed. The second room 142 and the third room 143 are filled with the second liquid crystal 212 in different amounts since each of the second room 142 and the third room 143 is partially filled with the first liquid crystal 211. In addition, a first amount of the second liquid crystal 212 injected into the second room 142 is less than a second amount of the second liquid crystal 212 injected into the third room 143.

After performing the injection process for the second liquid crystal 212, the second receptacle 262 is spaced apart from the display panel 201.

Referring to FIG. 1F, the first inlet 131, the second inlet 132, and the third inlet 133 are blocked by a sealant 270 to seal the first room 141, the second room 142, and the third room 143.

Since the first room 141 is fully filled with the first liquid crystal 211 including the chiral dopant at the first amount, a first cholesteric liquid crystal layer 211A may be formed in the first room 141, thereby emitting a blue light having a short wavelength. The second room 142 is filled with the first liquid crystal 211 at the second amount mixed with the second liquid crystal 212 at the first amount, thus a second cholesteric liquid crystal layer 213A including the chiral dopant at the second amount less than the first amount of the chiral dopant may be formed in the second room 142. The second cholesteric liquid crystal layer 213A may emit a green light having a wavelength longer than that of the blue light. The third room 143 is filled with the first liquid crystal 211 at the third amount mixed with the second liquid crystal 212 at the second amount, so that a third cholesteric liquid crystal layer 215A including the chiral dopant at the third amount less than the second amount of the chiral dopant may be formed in the third room 143. The third cholesteric liquid crystal layer 215A may emit a red light having a wavelength longer than that of the green light. Therefore, the display panel 201 including the first cholesteric liquid crystal layer 211A, the second cholesteric liquid crystal layer 213A, and the third cholesteric liquid crystal layer 215A arranged in a vertical strip shape is manufactured.

If the display panel 201 is operated in a reflection display mode, the display panel 201 may be operated using an electric field vertically applied to the first cholesteric liquid crystal layer 211A, the second cholesteric liquid crystal layer 213A, and the third cholesteric liquid crystal layer 215A. In particular, the electric field is generated by voltages applied to the pixel electrode PE (shown in FIG. 1A) and the common electrode (not shown), and the first cholesteric liquid crystal layer 211A, the second cholesteric liquid crystal layer 213A, and the third cholesteric liquid crystal layer 215A are arranged in a planar state or a focal conic state by the electric field. In the planar state, the first cholesteric liquid crystal layer 211A emits the blue light after receiving light, the second cholesteric liquid crystal layer 213A emits the green light after receiving light, and the third cholesteric liquid crystal layer 215A emits the red light after receiving light. Thus, the planar state may be defined as a reflective state. In the focal conic state, the first cholesteric liquid crystal layer 211A, the second cholesteric liquid crystal layer 213A, and the third cholesteric liquid crystal layer 215A scatter or transmit the light. The focal conic state may be defined as a black state since an absorbing layer (not shown) formed on the lower surface of the first substrate 100 absorbs the scattered light or the transmitted light.

Meanwhile, in order to form three cholesteric liquid crystal layers including the chiral dopant in different amounts from each other, in general, three liquid crystal injection processes, three sealing processes, and two cutting processes may be required. However, according to the first exemplary embodiment of the present invention, the first cholesteric liquid crystal layer 211A in the first room 141, the second cholesteric liquid crystal layer 213A in the second room 142, and the third cholesteric liquid crystal layer 213A in the third room 143 may be formed by performing two liquid crystal injection processes for the first liquid crystal 211 and the second liquid crystal 212 and one sealing process. That is, the first cholesteric liquid crystal layer 211A, the second cholesteric liquid crystal layer 213A, and the third cholesteric liquid crystal layer 215A each having a different chiral dopant amount from each other may be formed by using the first liquid crystal 211 (shown FIG. 1D) and the second liquid crystal 212 (shown in FIG. 1E). Thus, the manufacturing process of the display apparatus may be simplified, the manufacturing process efficiency may be improved, and the manufacturing cost of the display apparatus may be reduced.

Furthermore, when the size of the second inlet 132 (shown in FIG. 1D) of the second room 142 is adjusted, the amount of the chiral dopant in the second cholesteric liquid crystal layer 213A may be controlled. As a result, the second cholesteric liquid crystal layer 213A may emit green light having a desired wavelength in correspondence with the control of the amount of the chiral dopant. In addition, when the size of the third inlet 133 (shown in FIG. 1D) of the third room 143 is adjusted, the amount of the chiral dopant in the third cholesteric liquid crystal layer 215A may be controlled. Thus, the third cholesteric liquid crystal layer 215A may emit red light having a desired wavelength in correspondence with the control of the amount of the chiral dopant. The size of the second inlet 132 of the second room 142 and the size of the third inlet 133 of the third room 143 may be controlled by adjusting the second width W2 of the first width adjuster 123 (shown in FIG. 1B) and/or the third width W3 of the second width adjuster 124 (shown in FIG. 1B).

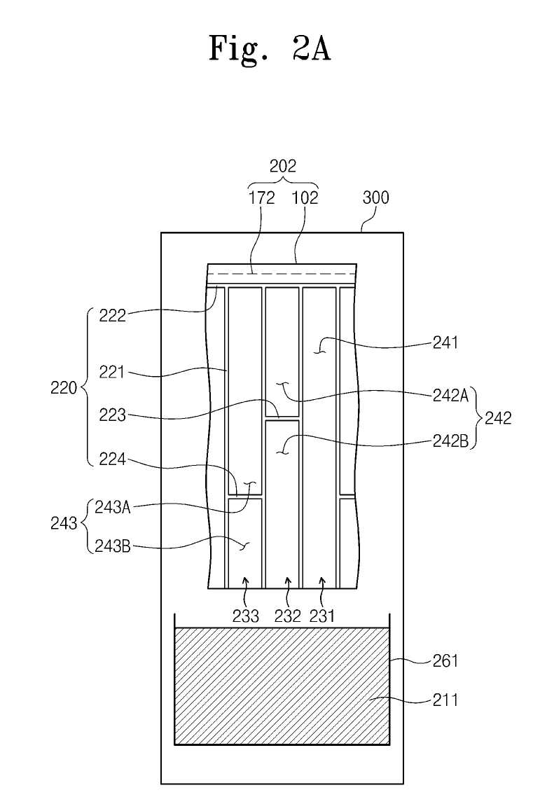

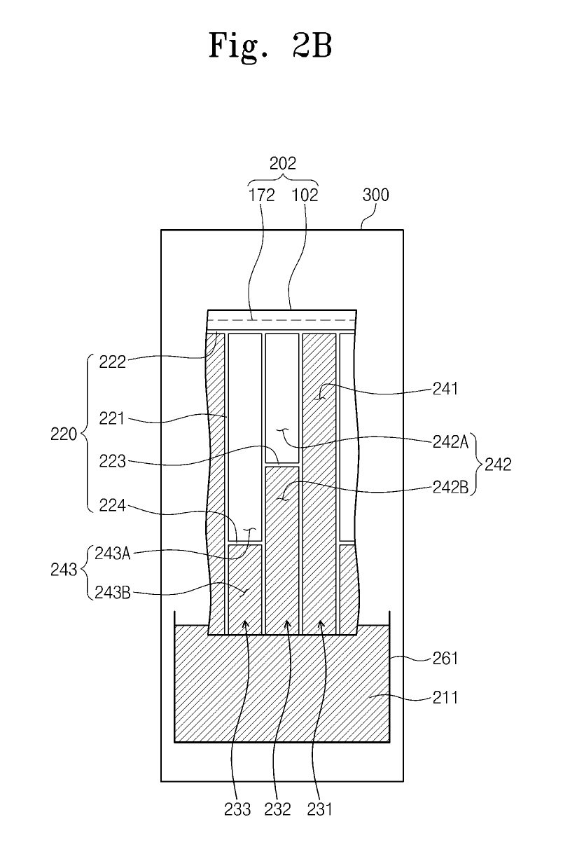

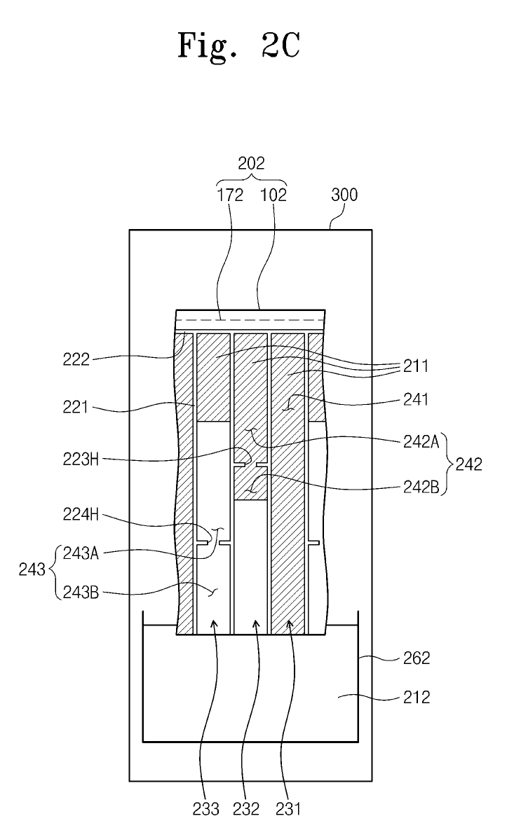

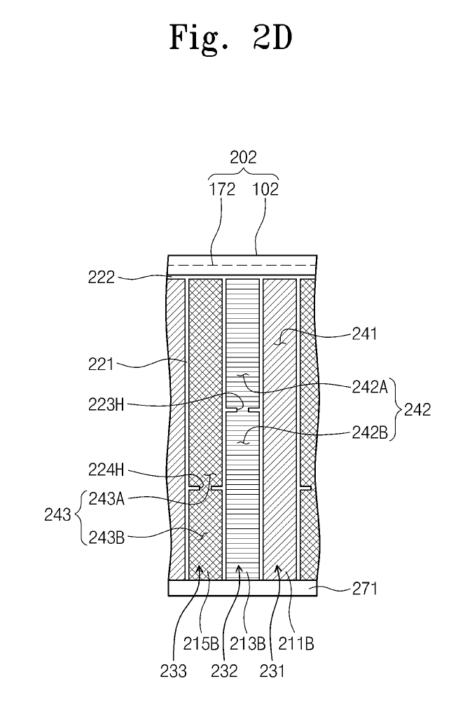

FIG. 2A, FIG. 2B, FIG. 2C, and FIG. 2D are views illustrating a method of manufacturing a display device according to a second exemplary embodiment of the present invention. Portions of the method of the second exemplary embodiment are similar to those described in the method of the first exemplary embodiment, and thus detailed descriptions of the similar portions will be omitted.

Referring to FIG. 2A, a first substrate 102 and a second substrate 172 are prepared, and then a barrier pattern 220 is formed on the first substrate 102 or the second substrate 172. Similar to the method described in FIG. 1B, when the first substrate 102 is coupled to the second substrate 172, a display panel 202 including the barrier pattern 220 disposed between the first and second substrates 102 and 172 is manufactured.

The display panel 202 includes a first room 241, a second room 242, and a third room 243 that are separated by the barrier pattern 220 and disposed between the first substrate 102 and the second substrate 172. The barrier pattern 220 includes first barriers 221, a second barrier 222, a first sub-barrier 223, and a second sub-barrier 224. The first barriers 221 extend in a first direction and are spaced apart from each other. The second barrier 222 extends in a second direction substantially perpendicular to the first direction to connect first ends of the first barriers 221 with each other. As described above, a space between the first substrate 102 and the second substrate 172 may be divided into the first room 241, the second room 242, and the third room 243 by the first barriers 221 and the second barrier 222.

The first room 241 has a first inlet 231, the second room 242 has a second inlet 232, and the third room 243 has a third inlet 233. The second room 242 is divided into a first sub-room 242B and a second sub-room 242A by the first sub-barrier 223, and the third room 243 is divided into a third sub-room 243B and a fourth sub-room 243A by the second sub-barrier 224. The first sub-room 242B has a volume greater than a volume of the third sub-room 243B.

The display panel 202 is transferred to and carried in a process chamber 300. A first receptacle 261 in which a first liquid crystal 211 is filled is prepared in the process chamber 300. The first liquid crystal 211 may be doped with a chiral dopant at a first amount. The display panel 201 carried in the process chamber 300 is located at a position spaced apart from the first receptacle 261. Then, when a pressure inside the process chamber 300 decreases, the first room 241, the second room 242, and the third room 243 may be in a vacuum state.

Referring to FIG. 2B, when the pressure inside the process chamber 300 increases after moving the display panel 202 to the first receptacle 261 such that the first inlet 231, the second inlet 232, and the third inlet 233 make contact with or are dipped into the first liquid crystal 211, the first liquid crystal 211 is injected into the first room 231, the first sub-room 242B, and the third sub-room 243B until the first room 231, the first sub-room 242B, and the third sub-room 243B are fully filled with the first liquid crystal 211.

After performing the injection process of the first liquid crystal 211, the first receptacle 261 is spaced apart from the display panel 202.

Referring to FIG. 2C, the display panel 202 is transferred to above a second receptacle 262 in which a second liquid crystal 212 is filled, or the second receptacle 262 is transferred to below the display panel 202. Then, the display panel 202 makes contact with or is dipped into the second liquid crystal 212. The second liquid crystal 212 may not include the chiral dopant. When the display panel 202 makes contact with or is dipped into the second liquid crystal 212, the first sub-barrier 223 and the second sub-barrier 224 may be removed. Due to the removing process, a first hole 223H is formed through the first sub-barrier 223 and a second hole 224H is formed through the second sub-barrier 224, so that the first sub-room 242B is connected with the second sub-room 242A, and the third sub-room 243B is connected with the fourth sub-room 243A. The first and second holes 223H and 224H may be formed by using a laser beam.

Then, the pressure inside the process chamber 300 increases to inject the second liquid crystal 212 into the second room 242 and the third room 243. The injection process for the second liquid crystal 212 may be performed until the second room 242 and the third room 243 each of which is partially filled with the first liquid crystal 211 is filled with the second liquid crystal 212. In this case, the first liquid crystal 211 injected into the first sub-room 242B and the third sub-room 243B may move through the first hole 223H and the second hole 224H, respectively. The first room 241 is fully filled with the first liquid crystal 211, so that the second liquid crystal 212 is not injected into the first room 241 even if the injection process for the second liquid crystal 212 is performed. The second and third rooms 242 and 243 are filled with the second liquid crystal 212 in different amounts. In addition, a first amount of the second liquid crystal 212 injected into the second room 242 is less than a second amount of the second liquid crystal 212 injected into the third room 243.

After performing the injection process for the second liquid crystal 212, the second receptacle 262 is spaced apart from the display panel 202.

Referring to FIG. 2D, the first inlet 231, the second inlet 232, and the third inlet 233 are blocked by a sealant 271 to seal the first room 241, the second room 242, and the third room 243.

Since the first room 241 is fully filled with the first liquid crystal 211 including the chiral dopant at the first amount, a first cholesteric liquid crystal layer 211B may be formed in the first room 241, thereby emitting a blue light having a short wavelength. The second room 242 is filled with the first liquid crystal 211 at the second amount mixed with the second liquid crystal 212 at the first amount, and thus a second cholesteric liquid crystal layer 213B including the chiral dopant at the second amount less than the first amount of the chiral dopant may be formed in the second room 242. The second cholesteric liquid crystal layer 213B may emit a green light having a wavelength longer than that of the blue light. The third room 243 is filled with the first liquid crystal 211 at the third amount mixed with the second liquid crystal 212 at the second amount, so that a third cholesteric liquid crystal layer 215B including the chiral dopant at the third amount less than the second amount of the chiral dopant may be formed in the third room 243. The third cholesteric liquid crystal layer 215B may emit a red light having a wavelength longer than that of the green light. Therefore, the display panel 202 including the first cholesteric liquid crystal layer 211B, the second cholesteric liquid crystal layer 213B, and the third cholesteric liquid crystal layer 215B arranged in a vertical strip shape is manufactured.

According to the second exemplary embodiment of the present invention, the first liquid crystal 211 may be injected into the first room 241, the second room 242, and the third room 243 in the different amounts from each other by the first sub-room 242B, the third room 243B, and the first room 241 having different volumes from each other. Thus, the amount of the second liquid crystal 212 injected into the second room 242 is different from the amount of the second liquid crystal 212 injected into the third room 243 through the injection process for the second liquid crystal 212. That is, the first cholesteric liquid crystal layer 211B, the second cholesteric liquid crystal layer 213B, and the third cholesteric liquid crystal layer 215B having the different chiral dopant amounts from each other may be formed by using the first liquid crystal 211 (shown FIG. 2A) and the second liquid crystal 212 (shown in FIG. 2C).

Furthermore, when the position of the first sub-barrier 223 (shown in FIG. 2B) is adjusted, the amount of the chiral dopant in the second cholesteric liquid crystal layer 213B may be controlled. As a result, the second cholesteric liquid crystal layer 213B may emit green light having a desired wavelength in correspondence with the control of the amount of the chiral dopant. In addition, when the position of the second sub-barrier 224 (shown in FIG. 2B) is adjusted, the amount of the chiral dopant in the third cholesteric liquid crystal layer 215B may be controlled. Thus, the third cholesteric liquid crystal layer 215B may emit red light having a desired wavelength in correspondence with the control of the amount of the chiral dopant.

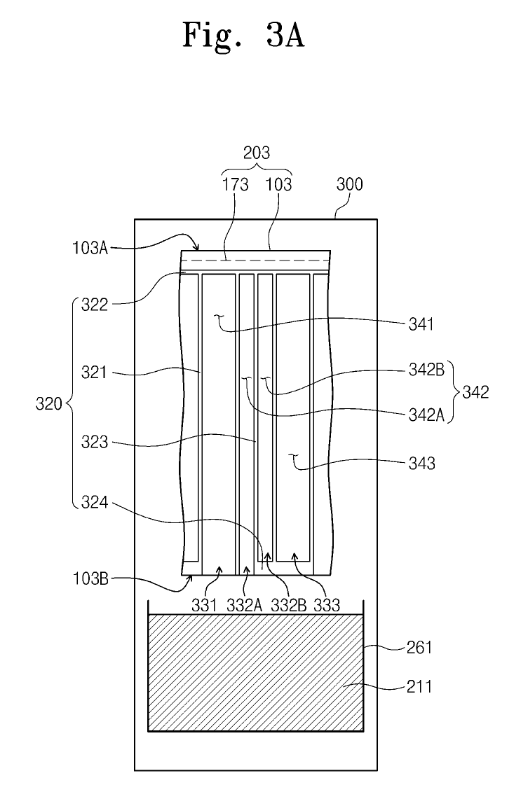

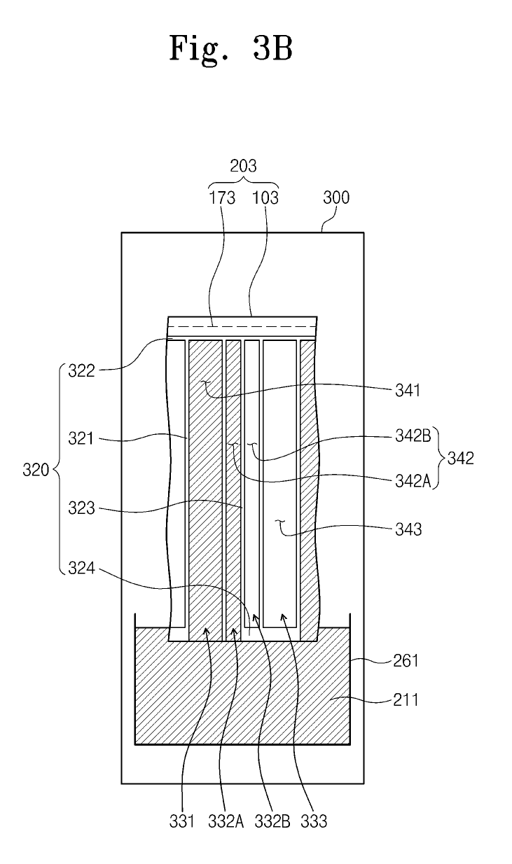

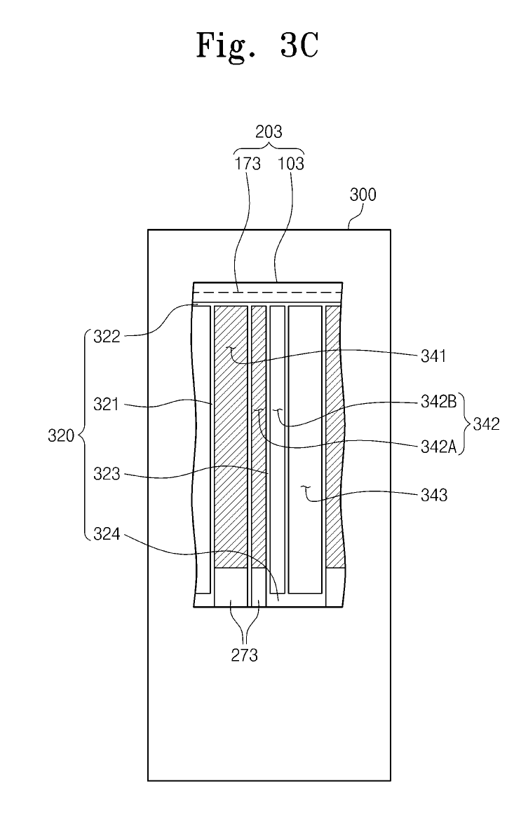

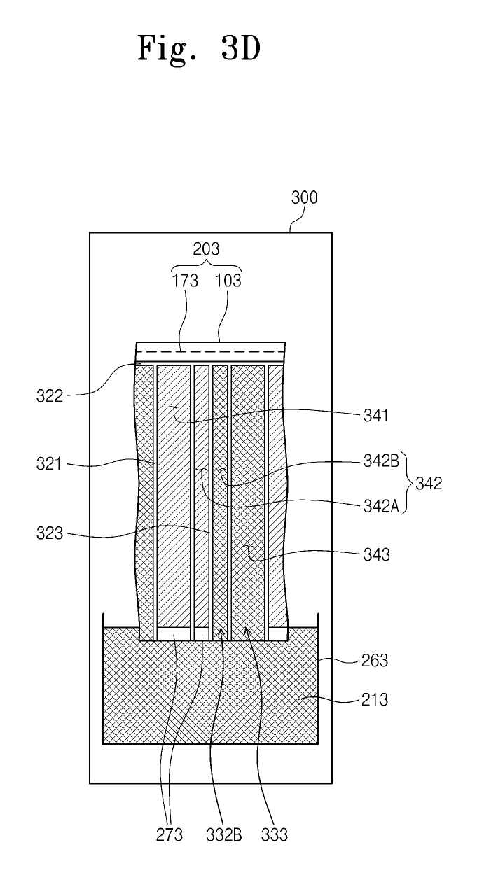

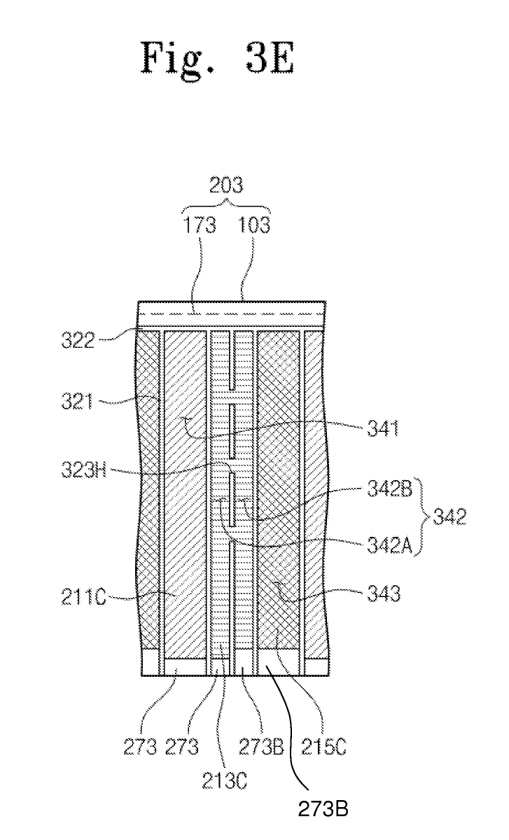

FIG. 3A, FIG. 3B, FIG. 3C, FIG. 3D, and FIG. 3E are views illustrating a method of manufacturing a display device according to a third exemplary embodiment of the present invention. Portions of the method of the third exemplary embodiment are similar to those described in the method of the first and second exemplary embodiments, and thus detailed descriptions of the similar portions will be omitted.

Referring to FIG. 3A, a first substrate 103 and a second substrate 173 are prepared. The first substrate 103 includes a first side 103B and a second side 103A opposite to the first side 103B. A barrier pattern 320 is formed on the first substrate 103 or the second substrate 173. Similar to the method described in FIG. 1B, when the first substrate 103 is coupled to the second substrate 173, a display panel 203 including the barrier pattern 320 disposed between the first and second substrates 103 and 173 is manufactured.

The display panel 203 includes a first room 341, a second room 342, and a third room 343 that are separated by the barrier pattern 320 and disposed between the first and second substrates 103 and 173. The barrier pattern 320 includes first barriers 321, a second barrier 322, a sub-barrier 323, and an injection blocking barrier 324. The first barriers 321 extend in a first direction and are spaced apart from each other. The second barrier 322 extends in a second direction substantially perpendicular to the first direction to connect first ends of the first barriers 321 with each other. As described above, a space between the first substrate 103 and the second substrate 173 may be divided into the first room 341, the second room 342, and the third room 343 by the first barriers 321 and the second barrier 322.

The first room 341 has a first inlet 331, the second room 342 has a second inlet 332A and 332B, and the third room 343 has a third inlet 333. The sub-barrier 323 extends in the first direction substantially parallel to the first barriers 321 in the second room 342, and thus the second room 342 is divided into a first sub-room 342A and a second sub-room 342B. In detail, the sub-barrier 323 extends toward the first and second sides 103B and 103A. Since the sub-barrier 323 is positioned at a center of the second room 342, the first sub-room 342A may have the same volume as that of the second sub-room 342B. The second inlet 332A and 332B is divided into a first sub-inlet 332A and a second sub-inlet 332B by the sub-barrier 323. The first inlet 331, the first sub-inlet 332A, the second sub-inlet 332B, and the third inlet 333 are located at positions adjacent to the first side 103B of the first substrate 103. The injection blocking barrier 324 is connected with the sub-barrier 323 and the first barriers 321 corresponding to the second sub-room 342B and the third room 343, respectively, to block the second sub-inlet 332B and the third inlet 333.

The display panel 203 is transferred to and carried in a process chamber 300. A first receptacle 261 in which a first liquid crystal 211 is filled is prepared in the process chamber 300. The first liquid crystal 211 may be doped with a chiral dopant at a first amount. The display panel 203 carried in the process chamber 300 is located at a position spaced apart from the first receptacle 261. Then, when a pressure inside the process chamber 300 decreases, the first room 341 and the first sub-room 342A may be in a vacuum state.

Referring to FIG. 3B, when the pressure inside the process chamber 300 increases after moving the display panel 203 to the first receptacle 261 such that the first inlet 331 and the first sub-inlet 332A make contact with or are dipped into the first liquid crystal 211, the first liquid crystal 211 is injected into the first room 341 and the first sub-room 342A until the first room 341 and the first sub-room 342A are fully filled with the first liquid crystal 211.

After performing the injection process of the first liquid crystal 211, the first receptacle 261 is spaced apart from the display panel 203.

Referring to FIG. 3C, a first sealant 273 is formed at the first inlet 331 and the first sub-inlet 332A to block the first inlet 331 and the first sub-inlet 332A. The first sealant 273 may include silicon-based adhesive. The first sealant 273 extends inside the first room 341 and the first sub-room 342A to have a thickness thicker than a thickness of the injection blocking barrier 324.

Referring to FIG. 3D, a portion of the first sealant 273 is removed with the injection blocking barrier 324 such that the second sub-inlet 332B and the third inlet 333 are opened while sealing the first room 341 and the first sub-room 342A each of which is filled with the first liquid crystal 211. Due to the removing process, a portion of the second substrate 173 may be cut with a portion of the barrier pattern 320.

The display panel 203 is transferred to above a second receptacle 263 in which a second liquid crystal 213 is filled, or the second receptacle 263 is transferred to below the display panel 203. Then, the second sub-inlet 332B and the third inlet 333 of the display panel 203 make contact with or are dipped into the second liquid crystal 213. The second liquid crystal 213 may be doped with a chiral dopant at a second amount less than the first amount of the chiral dopant.

Then, the pressure inside the process chamber 300 increases to inject the second liquid crystal 213 into the second sub-room 342B and the third room 343. The injection process for the second liquid crystal 213 may be performed until the second sub-room 342B and the third room 343 are filled with the second liquid crystal 213. After performing the injection process for the second liquid crystal 213, the second receptacle 263 is spaced apart from the display panel 203.

Referring to FIG. 3E, a second sealant 273B is formed at the second sub-inlet 332B and the third inlet 333 to seal the second sub-room 342B and the third room 343.

The sub-barrier 323 is partially removed to connect the first sub-room 342A to the second sub-room 342B. For example, a hole 323H is formed through the sub-barrier 323 such that the first sub-room 342A is connected with the second sub-room 342B. Accordingly, the first liquid crystal 211 filled in the first sub-room 342A may be mixed with the second liquid crystal 213 filled in the second sub-room 342B through the hole 323H after the second room 342 is sealed. In the present exemplary embodiment, the hole 323H may be formed in plural numbers and formed by using a laser beam. In addition, the sub-barrier 323 is partially removed in FIG. 3E, but it should not be limited thereto or thereby. That is, all the sub-barrier may be removed by the laser beam.

The first liquid crystal 211 includes the chiral dopant at a first amount and the second liquid crystal 213 includes the chiral dopant at a second amount less than the first amount of the chiral dopant. Accordingly, a second cholesteric liquid crystal 213C including the chiral dopant at a third amount between the first and second amounts may be formed in the second room 342 by mixing the first liquid crystal 211 with the second liquid crystal 213. The second cholesteric liquid crystal layer 213C may emit a green light having a wavelength longer than a wavelength of a blue light. Since the first room 341 is fully filled with the first liquid crystal 211 including the chiral dopant at the first amount, a first cholesteric liquid crystal layer 211C may be formed in the first room 341, thereby emitting the blue light having a short wavelength. The third room 343 is fully filled with the second liquid crystal 213 including the chiral dopant at the second amount, so that a third cholesteric liquid crystal layer 215C may be formed in the third room 343. The third cholesteric liquid crystal layer 215C may emit a red light having a wavelength longer than that of the green light. Therefore, the display panel 203 including the first cholesteric liquid crystal layer 211C, the second cholesteric liquid crystal layer 213C, and the third cholesteric liquid crystal layer 215C arranged in a vertical strip shape is manufactured.

According to the third exemplary embodiment of the present invention, the first sub-room 342A and the second sub-room 342B may have the same volume. Thus, the first liquid crystal 211 filled in the first sub-room 342A may be mixed with the second liquid crystal 213 filled in the second sub-room 342B, to thereby form the second cholesteric liquid crystal 213C.

Furthermore, when the position of the sub-barrier 323 is adjusted such that the sub-barrier 323 is formed closer to the first room 341 or the third room 343, the amount of the chiral dopant in the second cholesteric liquid crystal layer 213C may be controlled. As a result, the second cholesteric liquid crystal layer 213C may emit green light having a desired wavelength in correspondence with the control of the amount of the chiral dopant.

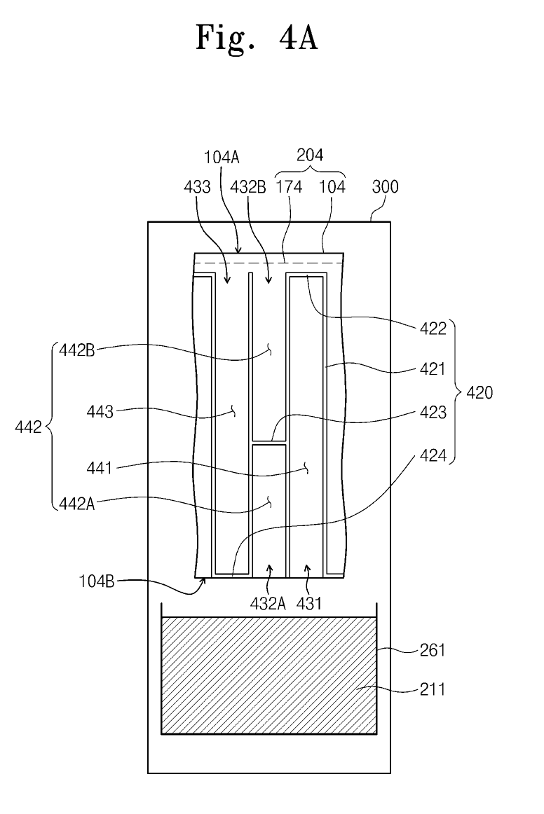

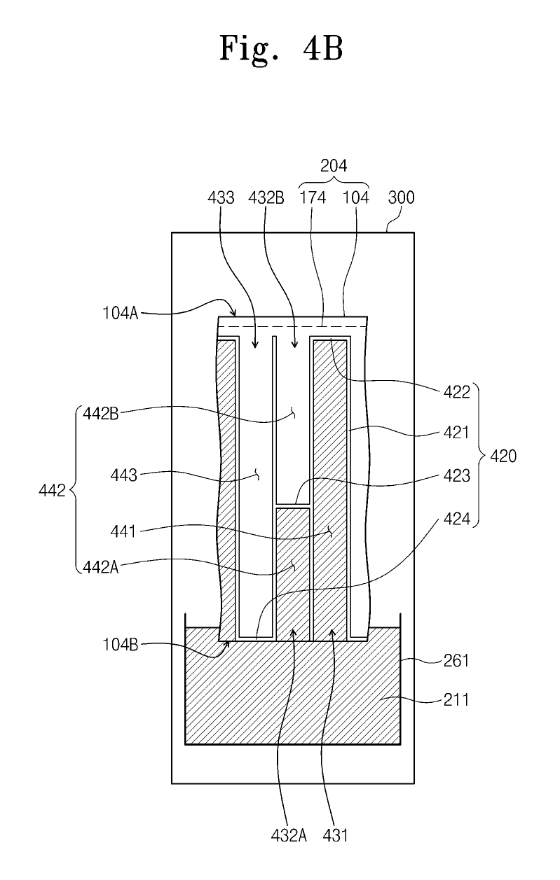

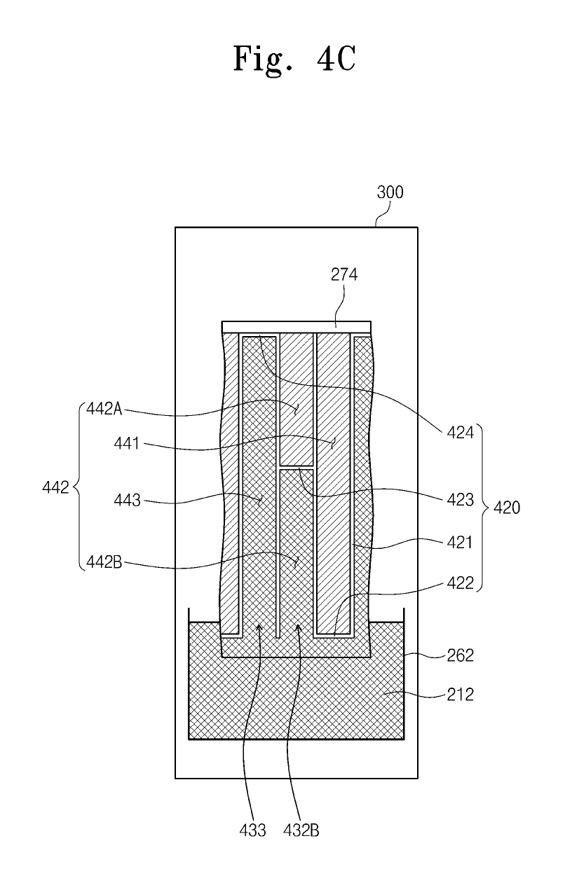

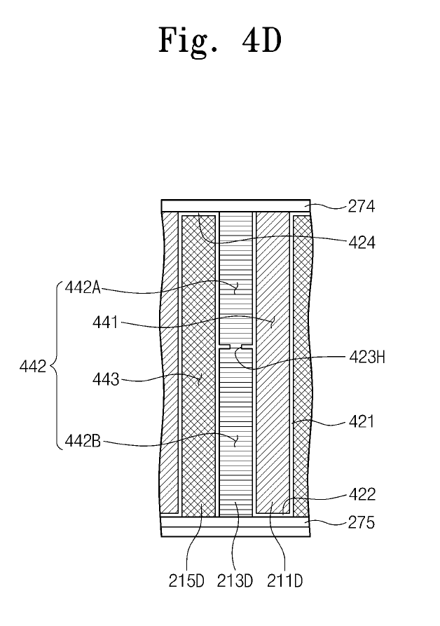

FIG. 4A, FIG. 4B, FIG. 4C, and FIG. 4D are views illustrating a method of manufacturing a display device according to a fourth exemplary embodiment of the present invention. Portions of the method of the fourth exemplary embodiment are similar to those described in the method of the first exemplary embodiment and the third exemplary embodiment, and thus detailed descriptions of the similar portions will be omitted.

Referring to FIG. 4A, a first substrate 104 and a second substrate 174 are prepared, and then a barrier pattern 420 is formed on the first substrate 104 or the second substrate 174. Similar to the method described in FIG. 1B, when the first substrate 104 is coupled to the second substrate 174, a display panel 204 including the barrier pattern 420 disposed between the first and second substrates 104 and 174 is manufactured.

The display panel 204 includes a first room 441, a second room 442, and a third room 443, which are separated by the barrier pattern 420 and disposed between the first and second substrates 104 and 174. The first substrate 104 includes a first side 104B and a second side 104A opposite to the first side 104B. The first room 441 includes a first inlet 431 adjacent to the first side 104B. The second room 442 includes a first sub-room 442A and a second sub-room 442B. The first sub-room 442A includes a first sub-inlet 432A adjacent to the first side 104B, and the second sub-room 442B includes a second sub-inlet 432B adjacent to the second side 104A. The third room 443 includes a third inlet 433 adjacent to the second side 104A. The barrier pattern 420 includes first barriers 421, a second barrier 422, a third barrier 424, and a sub-barrier 423. The first barriers 421 extend in parallel with each other and are spaced apart from each other. The second barrier 422 is adjacent to the second side 104A and may connect the first barriers 421 with each other corresponding to the first room 441. The third barrier 424 is adjacent to the first side 104B and may connect the first barriers 421 with each other corresponding to the third room 443. The sub-barrier 423 is disposed between the first barriers 421 corresponding to the second room 442 to divide the second room 442 into the first sub-room 442A and the second sub-room 442B.

The display panel 204 is transferred to and carried in a process chamber 300. A first receptacle 261 in which a first liquid crystal 211 is filled is prepared in the process chamber 300. The first liquid crystal 211 may be doped with a chiral dopant at a first amount. The display panel 204 carried in the process chamber 300 is located at a position spaced apart from the first receptacle 261. Then, when a pressure inside the process chamber 300 decreases, the first room 441 and the first sub-room 442A may be in a vacuum state.

Referring to FIG. 4B, when the pressure inside the process chamber 300 increases to the ambient atmospheric pressure, for example, 1 atmosphere, after moving the display panel 204 to the first receptacle 261 such that the first inlet 431 and the first sub-inlet 432A make contact with or are dipped into the first liquid crystal 211, the first room 441 and the first sub-room 442A may be fully filled with the first liquid crystal 211.

After performing the injection process of the first liquid crystal 211, the first receptacle 261 is spaced apart from the display panel 204.

Referring to FIG. 4C, a first sealant 274 is formed at the first inlet 431 and the first sub-inlet 432A to block the first inlet 431 and the first sub-inlet 432A. The first sealant 274 may include silicon-based adhesive.

The display panel 204 is transferred to above a second receptacle 262 in which a second liquid crystal 212 is filled, or the second receptacle 262 is transferred to below the display panel 204. Then, the second sub-inlet 432B and the third inlet 433 of the display panel 204 make contact with or are dipped into the second liquid crystal 212. The second liquid crystal 212 may include the chiral dopant at a second amount less than the first amount of the chiral dopant of the first liquid crystal 211.

Then, the pressure inside the process chamber 300 increases to inject the second liquid crystal 212 into the second sub-room 442B and the third room 443. The injection process for the second liquid crystal 212 may be performed until the second sub-room 442B and the third room 443 are filled with the second liquid crystal 212. After performing the injection process for the second liquid crystal 212, the second receptacle 262 is spaced apart from the display panel 204.

Referring to FIG. 4D, a second sealant 275 is formed at the second sub-inlet 432B (shown in FIG. 4B) and the third inlet 433 to block the second sub-room 442B and the third room 443. Thus, the second room 442A and 442B is sealed by the first sealant 274 and the second sealant 275. The sub-barrier 423 is partially removed to connect the first sub-room 442A with the second sub-room 442B. Due to the removing process, a hole 423H is formed through the sub-barrier 423, so that the first sub-room 442A may be connected with the second sub-room 442B. The hole 423H may be formed by using a laser beam.

The first liquid crystal 211 filled in the first sub-room 442A may be mixed with the second liquid crystal 212 filled in the second sub-room 442B after the second room 442 is sealed. The first liquid crystal 211 includes the chiral dopant at a first amount and the second liquid crystal 212 includes the chiral dopant at a second amount less than the first amount. Accordingly, a second cholesteric liquid layer 213D including the chiral dopant at a third amount between the first amount and the second amount may be formed in the second room 442 (i.e., the first sub-room 442A and the second sub-room 442B) by mixing the first liquid crystal 211 with the second liquid crystal 212. The second cholesteric liquid crystal layer 213D may emit a green light having a wavelength longer than that of a blue light. Since the first room 441 is fully filled with the first liquid crystal 211 including the chiral dopant at the first amount, a first cholesteric liquid crystal layer 211D may be formed in the first room 441, thereby emitting a blue light having a short wavelength. The third room 443 is filled with the second liquid crystal 212 including the chiral dopant at the second amount, so that a third cholesteric liquid crystal layer 215D may be formed in the third room 443. The third cholesteric liquid crystal layer 215D may emit a red light having a wavelength longer than that of the green light. Therefore, the display panel 204 including the first cholesteric liquid crystal layer 211D, the second cholesteric liquid crystal layer 213D, and the third cholesteric liquid crystal layer 215D arranged in a vertical strip shape is manufactured.

According to the fourth exemplary embodiment of the present invention, the sub-barrier 423 may be easily removed. The sub-barrier 423 has a length shorter than that of the sub-barrier 323 (shown in FIG. 3A) according to the third exemplary embodiment, so that the number of the holes 423H formed through the sub-barrier 423 is less than the number of the holes 323H formed through the sub-barrier 323.

Furthermore, when the position of the sub-barrier 423 is adjusted such that the sub-barrier 423 is formed closer to the first sub-inlet 432A or the second sub-inlet 432B, the amount of the chiral dopant in the second cholesteric liquid crystal layer 213D may be controlled. As a result, the second cholesteric liquid crystal layer 213D may emit green light having a desired wavelength in correspondence with the control of the amount of the chiral dopant.

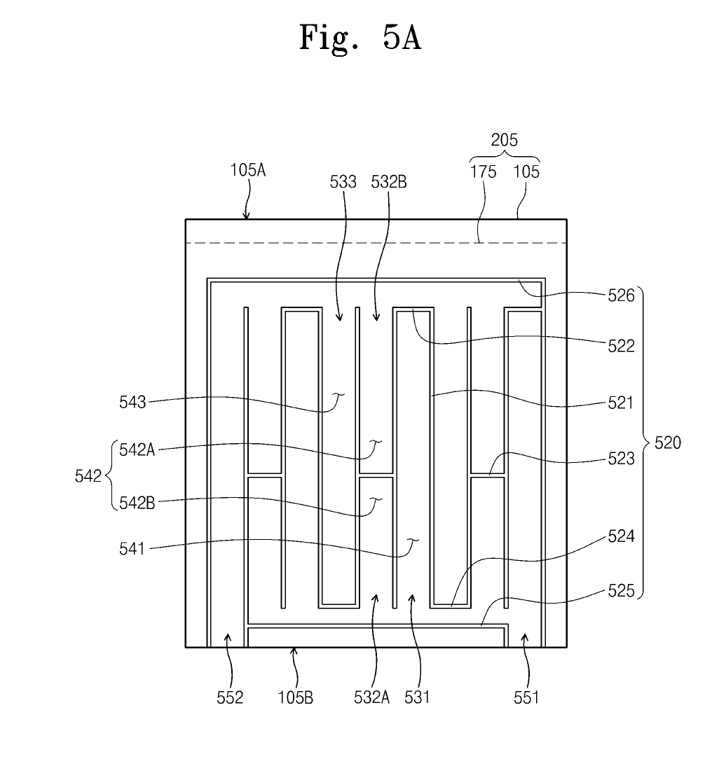

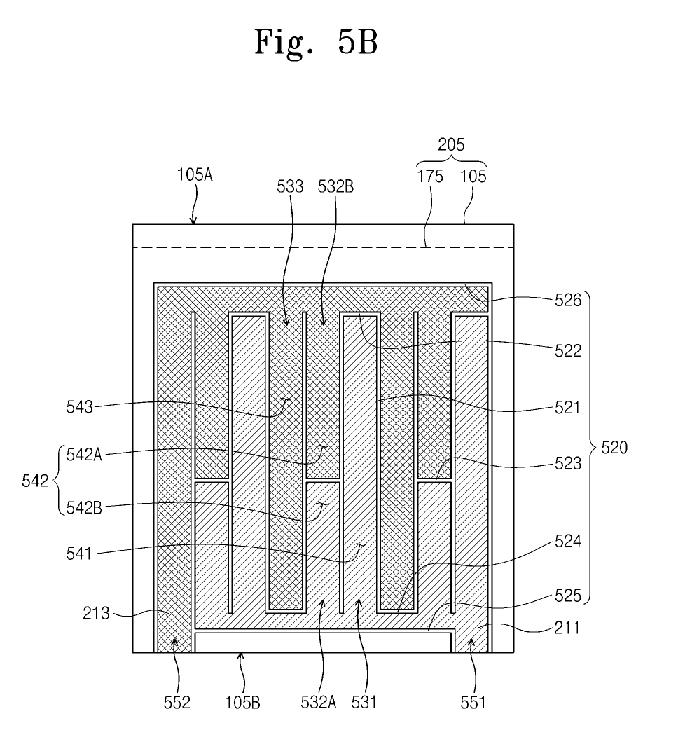

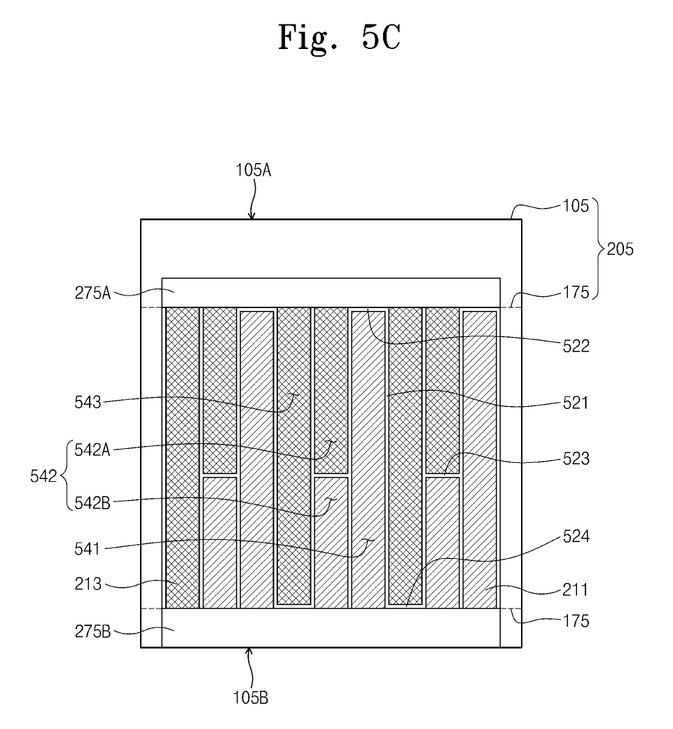

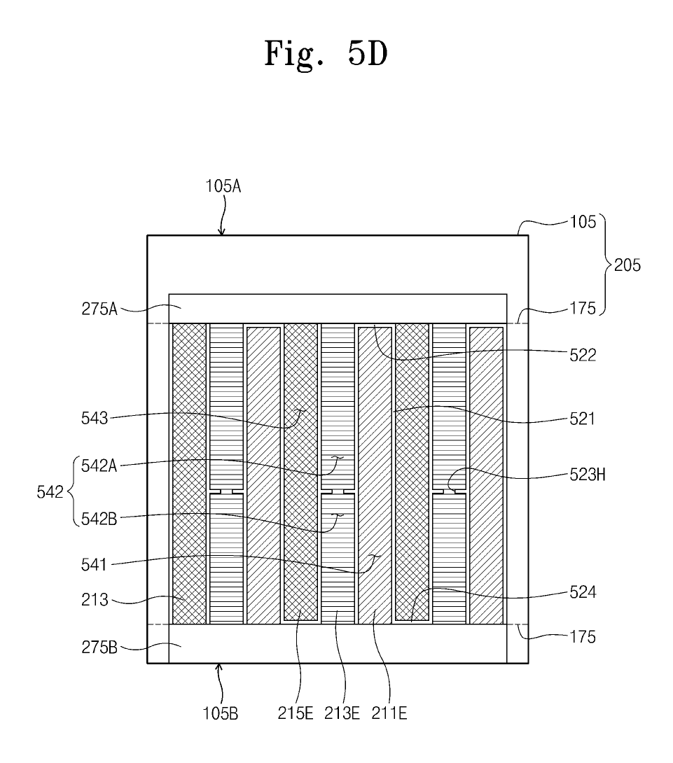

FIG. 5A, FIG. 5B, FIG. 5C, and FIG. 5D are views illustrating a method of manufacturing a display device according to a fifth exemplary embodiment of the present invention. Portions of the method of the fifth exemplary embodiment are similar to those described in the method of the first exemplary embodiment, and the fourth exemplary embodiment, and thus detailed descriptions of the similar portions will be omitted.

Referring to FIG. 5A, a first substrate 105 and a second substrate 175 are prepared, and then a barrier pattern 520 is formed on the first substrate 105 or the second substrate 175. The first substrate 105 includes a first side 105B and a second side 105A opposite to the first side 105B. Similar to the method described in FIG. 1B, when the first substrate 105 is coupled to the second substrate 175, a display panel 205 including the barrier pattern 520 disposed between the first and second substrates 105 and 175 is manufactured.

The display panel 205 includes a first room 541, a second room 542, and a third room 543, which are separated by the barrier pattern 520 and disposed between the first and second substrates 105 and 175. The first room 541 includes a first inlet 531 adjacent to the first side 105B. The second room 542 is divided into a first sub-room 542B and a second sub-room 542A. The first sub-room 542B includes a first sub-inlet 532A adjacent to the first side 105B, and the second sub-room 542A includes a second sub-inlet 532B adjacent to the second side 105A. The third room 543 includes a third inlet 533 adjacent to the second side 105A.

The barrier pattern 520 includes first barriers 521, a second barrier 522, a third barrier 524, a sub-barrier 523, a first injection barrier 525, and a second injection barrier 526. The first barriers 521 extend in parallel with each other and are spaced apart from each other. The second barrier 522 is adjacent to the second side 105A and may connect the first barriers 521 with each other corresponding to the first room 541. The third barrier 524 is adjacent to the first side 105B and may connect the first barriers 521 with each other corresponding to the third room 543. The sub-barrier 523 is disposed between the first barriers 521 corresponding to the second room 542 to divide the second room 542 into the first sub-room 542B and the second sub-room 542A. The first injection barrier 525 is adjacent to the first side 105B and positioned to block the first inlet 531 and the first sub-inlet 532A while spacing apart from the first inlet 531 and the first sub-inlet 532A. The second injection barrier 526 extends from outermost first barriers 521 and is positioned to block the second sub-inlet 532B and the third inlet 533 while spacing apart from the second sub-inlet 532B and the third inlet 533. Thus, a fourth inlet 551 and a fifth inlet 552 are formed by the first and second injection barriers 525 and 526. The fourth inlet 551 connects the first inlet 531 with the first sub-inlet 532A, and the fifth inlet 552 connects the second sub-inlet 532B and the third inlet 533.

Referring to FIG. 5B, a first liquid crystal 211 is injected into the first room 541 and the first sub-room 542B to fill the first room 541 and the first sub-room 542B. A second liquid crystal 213 is injected into the third room 543 and the second sub-room 542A to fill the third room 543 and the second sub-room 542A. The injection process for the first liquid crystal 211 may be performed simultaneously with or separately from the injection process for the second liquid crystal 213.

Referring to FIG. 5C, a portion of the second substrate 175 adjacent to the first side 105B of the first substrate 105 and a portion of the barrier pattern 520 corresponding to the fourth and fifth inlets 551 and 552 are removed to expose the first inlet 531 and the first sub-inlet 532A and to separate the first room 541 from the first sub-room 542B, into which the first liquid crystal 211 is injected. Then, a first sealant 275B is formed to seal the first inlet 531 (shown in FIG. 5B) and the first sub-inlet 532A.

A portion of the second substrate 175 adjacent to the second side 105A of the first substrate 105 and a portion of the second injection barrier 526 are removed to expose the second sub-inlet 532B and the third inlet 533 and to separate the third room 543 from the second sub-room 542A, into which the second liquid crystal 213 is injected. Then, a second sealant 275A is formed to seal the third inlet 533 and the second sub-inlet 532B.

The removing processes may be performed simultaneously with each other or separately from each other. Also, the sealing processes may be performed simultaneously with each other or separately from each other.

Referring to FIG. 5D, the sub-barrier 523 is partially removed to connect the first sub-room 542B with the second sub-room 542A. For example, a hole 523H may be formed through the sub-barrier 523 to connect the first sub-room 542B with the second sub-room 542A. The hole 523H may be formed by using a laser beam. Accordingly, the first liquid crystal 211 filled in the first sub-room 542B may be mixed with the second liquid crystal 213 filled in the second sub-room 542A after the second room 542 is sealed.

The first liquid crystal 211 includes the chiral dopant at a first amount and the second liquid crystal 213 includes the chiral dopant at a second amount less than the first amount. Accordingly, a second cholesteric liquid layer 213E including the chiral dopant at a third amount between the first amount and the second amount may be formed in the second room 542 by mixing the first liquid crystal 211 with the second liquid crystal 213. The second cholesteric liquid crystal layer 213E may emit a green light having a wavelength longer than that of a blue light. Since the first room 541 is fully filled with the first liquid crystal 211 including the chiral dopant at the first amount, a first cholesteric liquid crystal layer 211E may be formed in the first room 541, thereby emitting a blue light having a short wavelength. The third room 543 is filled with the second liquid crystal 213 including the chiral dopant at the second amount, so that a third cholesteric liquid crystal layer 215E including the chiral dopant at the second amount may be formed in the third room 543. The third cholesteric liquid crystal layer 215E may emit red light. Therefore, the display panel 205 including the first cholesteric liquid crystal layer 211E, the second cholesteric liquid crystal layer 213E, and the third cholesteric liquid crystal layer 215E arranged in a vertical strip shape is manufactured.

In the fourth exemplary embodiment, the first inlet 431 (shown in FIG. 4A) and the first sub-inlet 432A (shown in FIG. 4A) are adjacent to the first side 104B and opened toward the first side 104B. In addition, the second sub-inlet 432B (shown in FIG. 4A) and the third inlet 433 (shown in FIG. 4A) are adjacent to the second side 104A and opened toward the second side 104A. Different from these structures, according to the fifth exemplary embodiment, the fourth and fifth inlets 551 and 552 are adjacent to the first side 105B and opened toward the first side 105B. Thus, the injection process for the first liquid crystal 211 may be performed simultaneously with the injection process for the second liquid crystal 213.

According to the above, a manufacturing process of the display device is simplified and a manufacturing process efficiency of the display device increases, thereby reducing a manufacturing cost.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of manufacturing a display device, comprising:
forming a barrier pattern on a first substrate;
coupling a second substrate with the first substrate to form a first room, a second room, and a third room between the first substrate and the second substrate, the first room, the second room and the third room being separated by the barrier pattern; and
forming liquid crystal layers in the first room, the second room, and the third room, respectively, by using a first liquid crystal and a second liquid crystal obtained by doping the first liquid crystal with a dopant, each of the liquid crystal layers having a different amount of the dopant.

2. The method of claim 1, wherein the dopant comprises a chiral dopant, the first liquid crystal is not doped with the dopant, and the second liquid crystal comprises the dopant at a first amount.

3. The method of claim 2, wherein the liquid crystal layers comprise:
a first liquid crystal layer comprising the dopant at the first amount to emit a blue light;
a second liquid crystal layer comprising the dopant at a second amount less than the first amount to emit a green light; and
a third liquid crystal layer comprising the dopant at a third amount less than the second amount to emit a red light.

4. The method of claim 1, wherein the forming of the liquid crystal layers comprises:
disposing the second liquid crystal into the first room, the second room, and the third room in different amounts;
disposing the first liquid crystal into the second and third rooms into which the second liquid crystal is disposed; and
mixing the first liquid crystal and the second liquid crystal with each other in the second room and the first liquid crystal and the second liquid crystal with each other in the third room.

5. The method of claim 4, wherein the first room, the second room, and the third room each have an inlet of a different size from the other rooms, and the sizes of the inlets gradually decrease in order of the first room, the second room, and the third room.

6. The method of claim 4, wherein the second room is divided into a first sub-room and a second sub-room, the third room is divided into a third sub-room and a fourth sub-room, the first sub-room has a volume larger than a volume of the third sub-room, and the second liquid crystal is disposed into the first sub-room and the third sub-room.

7. The method of claim 6, wherein the first sub-room is separated from the second sub-room by a first sub-barrier, the third sub-room is separated from the fourth sub-room by a second sub-barrier, and the first sub-barrier and the second sub-barrier are removed before disposing the first liquid crystal.

8. The method of claim 1, wherein the dopant comprises a chiral dopant, the first liquid crystal comprises the dopant at a first amount, and the second liquid crystal comprises the dopant at a second amount greater than the first amount.

9. The method of claim 8, wherein the liquid crystal layers comprise:
a first liquid crystal layer comprising the dopant at the first amount to emit a red light;
a second liquid crystal layer comprising the dopant at the second amount to emit a blue light; and
a third liquid crystal layer comprising the dopant at a third amount between the first amount and the second amount to emit a green light.

10. The method of claim 9, wherein the forming of the liquid crystal layers comprises:
disposing the first liquid crystal into a portion of the first room and the second room;
disposing the second liquid crystal into the third room and a remaining portion of the second room; and
mixing the first liquid crystal in the portion of the second room with the second liquid crystal in the remaining portion of the second room.

11. The method of claim 10, wherein the barrier pattern comprises barriers extending in a first direction and spaced apart from each other, a space between the first substrate and the second substrate is divided into the first room, the second room, and the third room by the barriers, the second room is divided into a first sub-room and a second sub-room, the first liquid crystal is disposed in the first sub-room, and the second liquid crystal is disposed in the second sub-room.

12. The method of claim 11, wherein the first sub-room has substantially the same volume as the second sub-room.

13. The method of claim 11, further comprising removing a sub-barrier after disposing the first liquid crystal and the second liquid crystal, wherein the first sub-room and the second sub-room are separated from each other by the sub-barrier extending substantially perpendicular to the direction between the barriers corresponding to the second room.

14. The method of claim 11, wherein the first substrate comprises a first side and a second side opposite to the first side, each of the first room and the first sub-room comprises an inlet adjacent to the first side, and each of the second sub-room and the third room comprises an inlet adjacent to the second side.

15. The method of claim 14, further comprising removing a sub-barrier after disposing the first liquid crystal and the second liquid crystal, wherein the first sub-room is separated from the second sub-room by the sub-barrier disposed between the barriers corresponding to the second room.

16. The method of claim 14, wherein the barrier pattern comprises a first inlet connecting the inlet of the first room with the inlet of the first sub-room and a second inlet connecting the inlet of the third room with the inlet of the second sub-inlet, the first inlet and the second inlet are adjacent to the first side of the first substrate, the first liquid crystal is disposed into the first room and the first sub-room through the first inlet, and the second liquid crystal is disposed into the second sub-room and the third room through the second inlet.

17. The method of claim 16, wherein the first liquid crystal is disposed substantially simultaneously with the second liquid crystal.
